(19) United States
(12) Patent Application Publication
(10) Pub. No.: US 2002/0087437 A1
(43) Pub. Date: Jul. 4, 2002

(54) System and method for automated animal medicine inventory control

(76) Inventor: Thomas Hogan, Marietta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/752,989

(22) Filed: Jan. 2, 2001

(51) Int. Cl. G06F 17/60

(52) U.S. Cl. 705/28

(57) ABSTRACT

A system and method for automatic animal medicine inventory control utilizes a device such as a personal computer to track animal medicine arriving into a medicine stockpile, then continually update the medicine stockpile information as medicine is used during animal injection processes. As medicine stockpile levels reach a predetermined lower limit, an order for more medicine is automatically generated by an order driver driven by the personal computer.

### TECHNICAL FIELD

The present invention relates to systems and methods for automatically tracking depletion of stockpiled animal medicines and automatically re-ordering medicines when stockpile levels fall below predetermined limits.

### BACKGROUND INFORMATION

Among the many reasons for lack of profitability among producers of food animals, operational inefficiency ranks high. Cattlemen highly skilled and knowledgeable in some aspects of food animal production are notoriously challenged in areas relating to running their operations as businesses.

In an effort to minimize these inefficiencies, numerous advances have been made in tools available to cattlemen to assist them in efficient operations. For instance, automatic marking syringes such at the VAC-MARC®, an embodiment of which is disclosed and claimed in U.S. Pat. No. 5,911,494 to Hogan, offered for sale by the VAC-PAC Corporation of Marietta, Ga. (1-800-793-1671), allow cattlemen to automatically inject an animal with a medicine while marking the animal in a location proximal to the point of injection, thereby correcting many inefficiencies and errors in the animal injection process. Additionally, allowed U.S. patent application Ser. No. 09/803,820 to Hogan et al. entitled System and Method for Quality Assurance in Animal Medicine Delivery teaches a system for color coding medicine containers to facilitate ease of distinction between families of medicines, thereby making a cattleman's efforts to identify and use a certain type of medicine more efficient. Finally, pending U.S. patent application Ser. No. 09/477,262 to Hogan entitled System and Method for Automatically Recording Animal Vaccination Information provides an automatic system for verifiably recording and associating both an identity of an individual animal and information relating to medicines given the animal. The aforementioned U.S. Patent and pending applications are hereby specifically incorporated by reference herein.

One area of food animal production, however, retains the inefficiencies of years past. More specifically, cattlemen today evaluate their need for—and place orders to replenish—their animal medicine stockpiles in the same basic manner they always have. Essentially, a cattleman will physically inspect the refrigerator or other storage area for animal medicines, and when he notices that a particular medicine is in short supply, he will place an order. Today's almost all animal pharmaceutical companies accommodate on-line ordering as well as fax and telephone orders, but there is not yet any viable alternative to the physical inspection of the stockpile by the cattleman. If a cattleman gets too busy to order, or if he mistakenly thinks he has more of a particular medicine than he actually has, he could be left in a position of missing or delaying an important regimen.

Accordingly, there is a need for a system for animal medicine accountability whereby amounts of animal medicine used are automatically subtracted from a previously recorded amount of stockpiled medicine, resulting in a real-time, accurate indication of how much of any particular medicine in on-hand in a local stockpile.

There is a further need for a system for determining, in conjunction with the previously stated need, when the on-hand amount of medicine falls below a predetermined limit, thereby triggering an automatic re-order of the medicine.

### BRIEF SUMMARY OF THE INVENTION

The present invention relates to a novel system for automatic animal medicine inventory control.

An embodiment of the present invention includes a recorder for recording to a database of a computer the arrival of a supply quantity of an animal medicine into an animal injection environment. Once a supply quantity of a medicine in received into a cattleman's medicine stockpile, an intelligent syringe for simultaneously injecting an animal with an injection quantity of the animal medicine and then transmitting, responsive to actuation of the transmitting syringe, an information signal containing information relating to the actuation of the transmitting syringe, the resulting injection of the animal is accomplished and the amount injected upon actuation.

A receiver is positioned proximal to the injection arena for receiving the information signal from the intelligent syringe. After receipt, the receiver forwards the information to a database within a personal computer, where the information is stored.

A comparator in the personal computer automatically compares the cumulated injection quantities of the animal medicine injected by the intelligent syringe to the supply quantity of the animal medicine remaining in the medicine stockpile. If the amount of medicine remaining in the stockpile falls below a predetermined threshold, an order driver automatically transmits an order to a supplier of the medicine.

### BRIEF DESCRIPTION OF THE DRAWINGS

FIG. 1 depicts an exemplary embodiment of the present invention in an exemplary operating environment.

FIG. 2 depicts an exemplary embodiment of an intelligent syringe in accordance with an exemplary embodiment of the present invention.

FIG. 3 is a flow diagram detailing exemplary steps in performing the method of the present invention.

### DETAILED DESCRIPTION

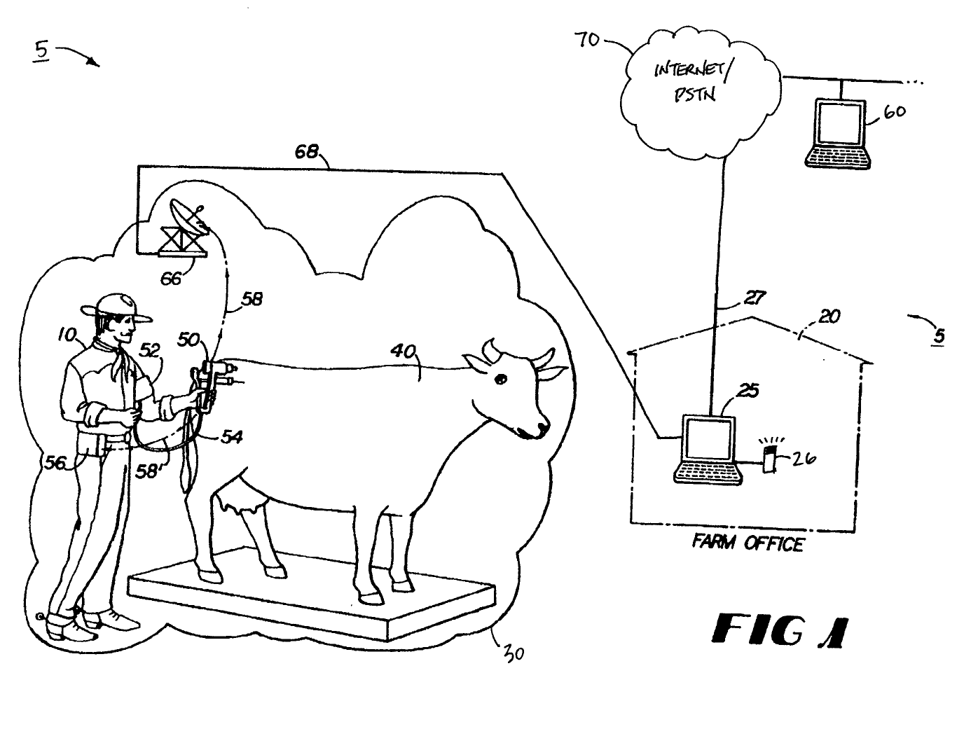

Referring now to the drawings, FIG. 1 depicts an exemplary embodiment of the present invention in an exemplary operating environment.

More specifically, the Inventory Control System 5 (hereinafter referred to as the “System”) features logistical and procedural devices by which a cattleman 10 can operate out of a farm office 20 and an injection area 30 to deliver injections to a food animal 40 via a transmitting syringe such as an intelligent syringe 50, automatically record information relating to the injections, then automatically transmit the information to a medicine supplier 60 via a transmission medium 70.

In operation, the cattleman 10 begins operation of the System 5 by entering identification data such as personal identification information into a personal computer (“PC”) 25 in his farm office 20. Additionally, the cattleman 10 enters into the PC 25 information relating to a supply quantity of medicine received into the cattleman's medicine stockpile from a medicine supplier 60. There are a variety of methods for entering the identity and quantities of medicine into a database of the PC 25, but a recorder such as a conventional barcode scanner 26 is the preferred mechanism because of its ease of use and virtual elimination of transcription errors. The effective implementation of such a barcode scanner 26 depends, of course on the medicines received into the stockpile being labeled with a barcode containing information such as the identity and the quantity of the medicine, etc. Once information regarding a particular stockpiled medicine has been entered into the database of the PC 25, the cattleman 10 is ready to begin the process of delivering individual doses of the medicine to the animal 40.

In preparation for an injection session, the cattleman 10 obtains a quantity of the medicine from his stockpile and identifies the medicine to the PC 25 as that which will be delivered to the animal 40. There are a variety of ways in which a particular medicine may be identified to the PC 25. The cattleman 10 may manually input into the PC 25 the identity of the medicine. Preferable to this, however is the use of a bar-code scanner proximal (or integral) to the intelligent syringe 50. In such a preferred embodiment, each session quantity—a quantity of a medicine sufficient to provide anywhere from 25 to 100 individual doses—is individually coded with information such as a medicine code identifying the medicine and a quantity code. As the session quantity is connected to the intelligent syringe, a barcode reader reads the medicine and quantity codes and makes the information available to a computer such as PC 25 for purposes such as those identified herein. In any event, after the medicine is identified to PC 25, the cattleman 10 continues to prepare to deliver injections to the animal 40 in accordance with the inventive concepts of the present invention.

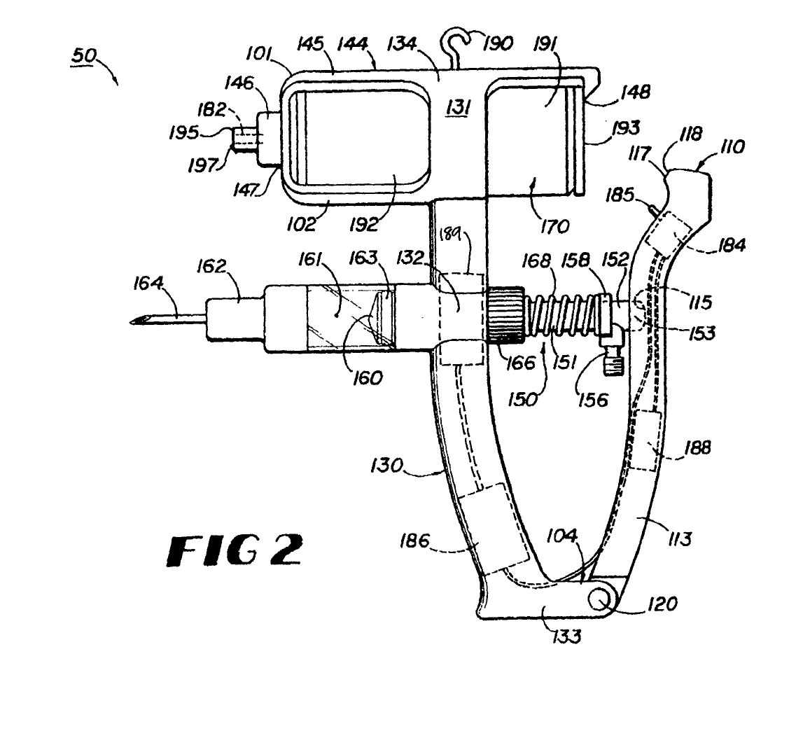

Further preparation for an injection session includes preparation of a syringe such as an intelligent syringe 50. The intelligent syringe 50, described with greater specificity during the later description of FIG. 2, is a syringe having the ability to substantially simultaneously deliver an injection to the animal 40 and transmit information relating to the type and quantity of medicine delivered to a database such as that in PC 25. In one embodiment of the invention, the intelligent syringe is also able to deliver a marking ink spot to the animal 40.

In one embodiment of the present invention, the intelligent syringe 50 is connected to a medicine reservoir 52 containing a quantity of medicine such as a session quantity of medicine via a medicine conduit 54. It is foreseen that many medical administrations will be of such a small amount, by volume, that the cattleman 10 can retain the medicine reservoir 52 on an arm, leg, in a backpack-type retention device, or even in the intelligent syringe 50, itself, for ease of mobility about the injection arena 30. In the embodiment in which a medicine reservoir 52 is used, the medicine conduit 54 is a flexible, tubular member securely interconnected between the intelligent syringe 50 and the medicine reservoir 52. As is well known to those skilled in the administration of medicines to animals, all medicine delivery components must comport with relevant health and safety regulations, especially in view of the highly toxic nature of many such medicines.

In preparation for commencement of animal injections, the cattleman 10 may also place a personal data device (“PDD”) 56 on his person for recording—manually or, preferably automatically—injection information as will be described momentarily.

Now that the System 5 is activated for use, and the necessary medicine delivery components 50, 52 and 54 are in place, an animal 40 is moved into the injection arena 30.

When the cattleman 10 delivers a medicine injection to the animal 40 via the intelligent syringe 50, the intelligent syringe 50 determines the amount of medicine delivered in a manner described further in reference to FIG. 2. Importantly, this injection information is delivered to the PC 25 for comparison to information such as medicine stockpile information, also maintained in the database of the PC 25.

Upon actuation of the intelligent syringe 50 to deliver medicine to the animal 40, the injection information may be automatically conveyed to the PC 25 through any variety of well-known mechanisms. One such mechanism is a transmitter located in the intelligent syringe 50. The transmitter, upon actuation of the syringe 50, transmits an injection signal 58 containing injection information either to a proximally located receiver 66 or to a personal data device (“PDD”) 56. It is also contemplated that the transmission of the injection signal 58 may occur via a conventional signal cable, though wireless transmission is far preferable.

If the injection signal 58 is received by the receiver 66, it is then relayed via communications link 68 to the PC 25. If the injection signal 58 is received by the PDD 56, the PDD 56 either transmits the information to the PC 25 via internet or other wireless connection, or periodically downloads the information to the PC 25 upon mating the PDD 56 to a so-called “hotsync cradle” or other physical connection through which information stored in the PDD 56 can be conveyed to the PC 25.

Once the injection information is received by the PC 25, a comparator such as any well known comparator software module makes the simple comparison between the quantity of medicine delivered to the animal 40 and the amount of medicine remaining in the medicine stockpile. Predetermined lower limits of acceptable medicine stock in the medicine stockpile have been set by the cattleman 10 or his agent, and when the level of medicine remaining in the medicine stockpile falls below that predetermined lower limit, an order driver automatically initiates an order for more medicine to replenish the medicine stockpile.

The order driver generates an order for more medicine that includes the type of medicine needed, preferred quantities—both session and overall—of the medicine, the identity of the purchaser and, likely, payment and delivery information. The information may be transmitted via the internet, via facsimile over the publicly switched telephone network, or an order card or purchase order may be generated for transmission via overland routes by carriers such as the US Post Office, FedEx, UPS, etc.

When the automatically placed order has been filled and arrives back at the farm office 20, it is entered into the database of the PC 25. The stockpile information maintained therein is then updated and the system 5 continues the stated process.

Referring now to FIG. 2, an exemplary embodiment of an intelligent syringe 50 in accordance with an exemplary embodiment of the present invention is shown. More particularly, the intelligent syringe 50 of the preferred embodiment comprises, generally, a syringe handle 104 operatively connected to an intelligent syringe 150 and an ink dispenser 170. The syringe handle 104 comprises a first syringe handle 110 pivotally connected to a second syringe handle 130. The first syringe handle 110 is elongated, having a first end 111 and a second end 113. An ink dispenser interface 117 is located generally adjacent to the socket 115 on the handle 110. The handle 110 has a pivot hole in its second end 113.

The second syringe handle 130 of the intelligent syringe 50 is also elongated and has a first end 131 and a second end 133. The first end 131 of the second syringe handle 130 may securely receive a hook 190 for storage of the marking syringe 105 between uses. The second syringe handle 130 is configured to function as a finger grip for the user. The second end 133 of the second syringe handle 130 is sized to slidably straddle the second end 113 of the first handle 110 and has a pivot hole through its thickness. The second handle 130 includes an integral intelligent syringe collar 132 and an integral ink dispenser collar 134.

During assembly, the second end 133 of the second syringe handle 130 is positioned over the second end 113 of the first syringe handle 110 such that the pivot holes in the ends 113, 133 are axially aligned. Thereafter, a pivot pin 120 is inserted through the aligned holes and appropriately secured therein in any number of ways, including deforming distal ends of the pivot pin 120 so that the diameter of the pivot pin 120 is larger at the points of deformation than the diameter of the pivot pin receiving holes, thereby preventing withdrawal of the pivot pin 120 through the pivot receiving holes. After the pivot pin 120 is properly positioned and secured, the second syringe handle 130 rotates about the axis of the pivot pin 120 in a plane defined by the second syringe handle 130 and the first syringe handle 110. In use, the first and second handles 110, 130 are initially in a spread position. The user can then grip the first and second handles 110, 130 and squeeze them into a closed position as the handles 110, 130 pivot about the pin 120.

The intelligent syringe 150 is mounted between the handles 110, 130 by means of the collar 132 on the second syringe handle 130 and the socket 115 on the first syringe handle 110. The intelligent syringe 150 comprises an intelligent syringe head 152 with a ball 153, an extendible intelligent syringe shaft 151, an intelligent syringe biasing spring 168, an intelligent syringe plunger 160, an intelligent syringe dosage chamber 161, an intelligent syringe needle fastener 162, and a needle 164. In order to connect the syringe 150 to the handle 104, the dosage chamber 161 is threaded into the handle collar 132 of the handle 130, and the intelligent syringe head 152 is connected to the handle 110 by engaging the ball 153 of the head 152 into the socket 115 of the handle 110 in a well known manner.

The head 152 is hollow and further comprises an intelligent syringe nipple 156 and an intelligent syringe stop flange 158. The intelligent syringe nipple 156 may be integral to the hollow intelligent syringe head 152 and is sized to securely receive a syringe vaccine hose (not shown). Vaccine is delivered to the hollow interior cavity of the head 152 via the vaccine hose which is connected to a vaccine source (not shown). The intelligent syringe stop flange 158 extends laterally about the periphery of the intelligent syringe head 152.

The extendible intelligent syringe shaft 151 interconnects the syringe head 152 and the plunger 160. The shaft 151 has an interior axial conduit (not shown) which communicates at one end with the interior cavity of the head 152 and at the other end with an interior axial conduit (not shown) through the plunger 160. The syringe shaft 151 extends through an intelligent syringe collar 132 of the second syringe handle 130 and into the vaccine dosage chamber 161. In order to vary the amount of the dosage, the shaft 151 has a vaccine dosage adjust valve 166. The dosage adjust valve 166 comprises a collar that engages the plunger 160 on one end and is threaded onto the syringe shaft 151.

The intelligent syringe plunger 160 slides within the vaccine dosage chamber 161. An O-ring 163 creates a liquid tight seal between the periphery of the plunger 160 and the interior wall of the dosage chamber 161. The plunger 160 has a check valve (not shown) within its interior axial conduit that allows liquid to pass only in the direction toward the needle end of the syringe 150.

The vaccine dosage chamber 161 is formed of a translucent or transparent material and is secured at its first end to the intelligent syringe collar 132. The vaccine dosage chamber 161 may be scored with incremental graduations to assist a user in dosage measurements. At its second end, the vaccine dosage chamber 161 removably receives an intelligent syringe needle fastener 162. The intelligent syringe needle fastener 162 is fitted to capture a needle 164. A check valve (not shown) is fitted within the needle fastener 162 to allow liquid flow only out of the needle 164.

An intelligent syringe biasing spring 168 is disposed around the intelligent syringe shaft 151 between the intelligent syringe stop flange 158 and the vaccine dosage adjust valve 166. The biasing spring 168 is a compression spring which serves to return the syringe handles 110, 130 to their initial spread position after being squeezed closed by the user.

When the handles 110, 130 are squeezed together, the plunger 160 moves within the dosage chamber 161. The movement of the plunger 160 closes the check valve within the plunger 160 to force vaccine in the dosage chamber 161 through the check valve within the needle fastener 162 and out through the needle 164. When the handles 110, 130 are released by the user, the check valve within the needle fastener 162 closes to preclude fluid or air being drawn into the dosage chamber 161 through the needle 164. Simultaneously, the check valve within the plunger 160 opens to that vaccine is drawn into the dosage chamber 161 through the nipple 156, the hollow head 152, the conduit within the shaft 151, and the conduit within the plunger 160. By turning the dosage adjust valve 166, the length of the shaft 151 is changed. Changing the length of the shaft 151 changes the length of the plunger stroke, and the amount of medicine delivered through the needle 164 is correspondingly changed.

The ink dispenser 170 comprises a self contained storage unit 189. The self contained storage unit 189 may take any number of forms well known to those skilled in the art of marking substance apparatus, including, but not limited to, a canister, ajar, a tube, or the like. Further, the specific form of self contained storage unit 189 is dependent upon the type of ink being utilized. For instance, a pressurized canister maybe used to store ink, which is suspended in, or in the form of, a compressed gas. Alternatively, a structure such as that used to store household caulk may be used to store liquid ink.

To support and retain the self contained storage unit 189, the second handle 130 may further comprise an integral retention cage 144 extending from the ink dispenser collar 134. The retention cage 144 may take any number of forms well known to those skilled in the art of mechanical design. It will be appreciated that the form of the retention cage 144 is dependent upon the physical characteristics of the self contained storage unit 189 being used.

The self contained storage unit 189 may comprise a pressurized canister 191, the ink dispenser interface 117 having a contact point 118, a retention cage 144 having a body 145, a valve actuator 146, a tip opening 147, and a can detent 148. The pressurized canister 191 may contain ink in the form of an aerosol, a non-aerosol compressed gas, or the like. The pressurized canister may be mounted to the second handle 130 my means of the collar 134 and the retention cage 144. The pressurized canister 191 comprises a canister body 192 having a bottom surface 193, a valve trigger (not shown), and an ink discharge orifice 182. In order to install the pressurized canister 191 into the handle 104, the canister body is inserted into the handle collar 134 of the second syringe handle 130 and maneuvered into the retention cage 144 until the can detent 148 makes contact with the bottom surface 193 of the canister 191, thereby securely capturing the pressurized canister 191 within the retention cage 144.

After secure capture of the pressurized canister 191 within the retention cage 144, the ink discharge orifice 182 extends through the tip opening 147, and the valve trigger is positioned in contact with, or adjacent to, the valve actuator 146. When fully inserted, the retention cage 144 assures that the bottom of the pressurized canister 191 is aligned with the radial path of rotation of the ink dispenser contact point 118 on the second syringe handle 130, as defined by rotation of the second handle 130 about the pin 120.

Central to the preferred functionality of the system 5 is the transmitter circuitry integral to the intelligent syringe 50. In an exemplary embodiment, the transmitter circuitry comprises a transmit trigger 184, a transmitter 186, a power source 188, and a flow sensor 189. As depicted in FIG. 2, the transmit trigger 184 may be positioned within the handle 110 proximal to the ink dispenser contact point 117. The transmit trigger 184 supports a transmit sensor 185 positioned such that actuation of the intelligent syringe 50 by squeezing handles 110, 130 places the transmit sensor 185 in contact with the pressurized canister 191. The transmit trigger 184, powered by a power source 188 such as a battery, detects contact between the transmit sensor 185 and the pressurized canister 191 and relays an appropriate signal to the transmitter 186. As previously described with reference to FIG. 1, the specific characteristics of the transmitter 186 will vary depending on the particular embodiment of the present invention being practiced, but in all cases, the transmitter is of sufficient signal strength and signal complexity to transmit, at a minimum, the injection information to a receiver.

After the signal is sent from the transmit trigger 184 to the transmitter 186, any detected flow of medicine through the syringe 150 is reported to the transmitter 186 for inclusion in the injection information to be transmitted to a receiver such as receiver 66 or PDD 56. Depending on the configuration and capabilities of the transmitter 186, a processor for accomplishing this information manipulation may be integrally incorporated therein, or the processor may reside separately within or proximal to the intelligent syringe 50.

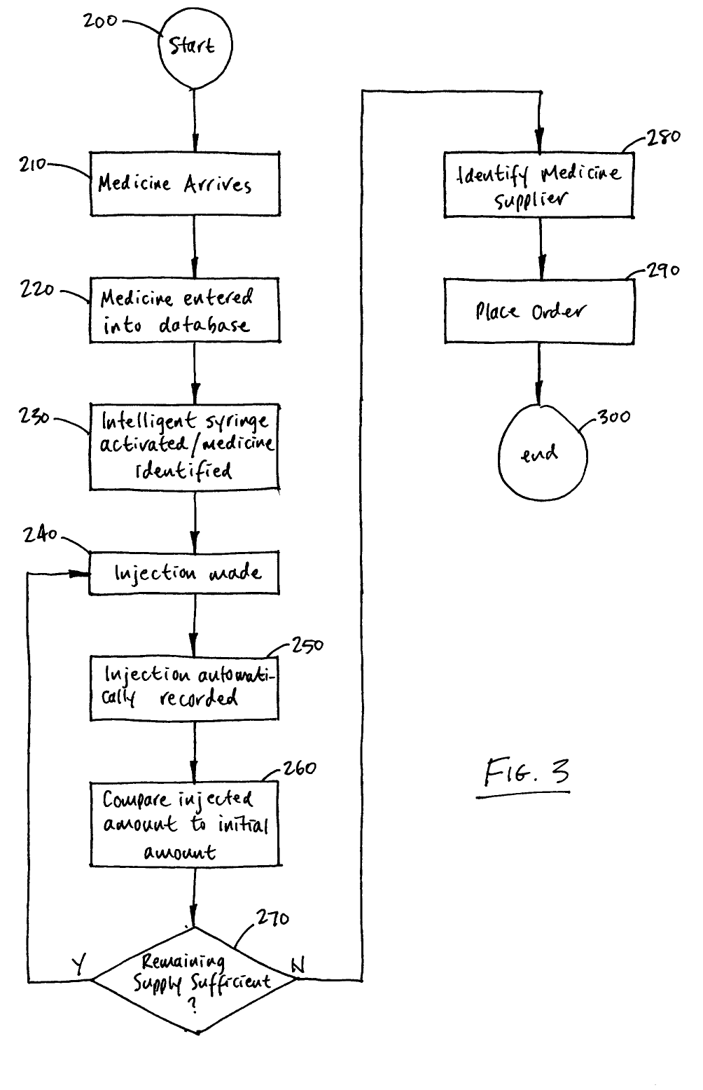

Turning now to FIG. 3, a flow diagram detailing exemplary steps in performing an embodiment of the method of the present invention is shown. The method begins at step 200 and, at step 210 a quantity of medicine arrives at the farm office 20 from a medicine suppler 60. At step 220, the type, quantity and other important details relating to the medicine are entered into a database interconnected or integral to a PC 25, preferably via receiver 26.

The intelligent syringe 50 is activated at step 230 and a session quantity of medicine is identified for injection into at least one animal. Thereafter, at step 240, an injection is made into the animal 40. The intelligent syringe 50 identifies at least the occurrence of the injection and the amount of medicine that flowed through the syringe 150 during the injection. The transmitter 186 transmits injection information containing information such as the amount and type of medicine to the database of the PC 25, where it is recorded at step 250.

A comparator with access to the initially recorded (and possibly subsequently updated) medicine stockpile information and incoming transmissions from the intelligent syringe 50 regarding the quantities of medicine injected into the animal performs a comparison at step 260. If, notwithstanding the injections, the amount of a stockpiled medicine exceeds a predetermined acceptable lower limit, there is no additional activity by the PC 25, and the injections continue as shown in decision block 270. When, however, the amount of a particular stockpiled medicine falls below the predetermined acceptable limit, a source for the medicine is identified at step 280 and, at step 290 an order for additional medicine to supplement the stockpile is automatically transmitted, preferably by either the internet or facsimile. The process ends at step 300.

It will be understood and appreciated that the spirit and scope of the present invention is not limited to the particular embodiments referenced and discussed herein, but to the claims appended hereto.

I claim:

1. A system for automated animal medicine inventory control, comprising:
a recorder for recording to a database of a computer the arrival of a supply quantity of an animal medicine into an animal injection environment;
an intelligent syringe for simultaneously injecting an animal with an injection quantity of the animal medicine and then transmitting, responsive to actuation of the intelligent syringe, a data signal containing information relating to the actuation of the intelligent syringe and the resulting injection of the animal;
an electronic identification device, attached to the animal, for providing an electronic identification of the animal;
a receiver for receiving the data signal from the intelligent syringe and the electronic identification of the animal;
a storage module in the database for storing the information contained in the data signal and the electronic identification;
a comparator in the computer for automatically comparing the cumulated injection quantities of the animal medicine injected by the intelligent syringe to the animal and other animals to the supply quantity of the animal medicine as recorded in the database; and
an order driver for transmitting an automated order for delivery of another supply quantity to the animal injection environment from an animal medicine supplier, responsive to the cumulated injection quantities coming within a predetermined margin of the supply quantity of animal medicine.

2. A system for automated animal medicine inventory control, comprising:
a recorder for recording to a database of a computer the arrival of a supply quantity of an animal medicine into an animal injection environment;
an intelligent syringe for simultaneously injecting an animal with an injection quantity of the animal medicine and then transmitting, responsive to actuation of the intelligent syringe, a data signal containing information relating to the actuation of the intelligent syringe and the resulting injection of the animal;
a receiver for receiving the data signal from the intelligent syringe;
a computer having a database for storing the information contained in the data signal;
a comparator in the computer for automatically comparing the cumulated injection quantities of the animal medicine injected by the intelligent syringe to the supply quantity of the animal medicine as recorded in the database; and
an order driver for transmitting an automated order for delivery of another supply quantity to the animal injection environment from an animal medicine supplier, responsive to the cumulated injection quantities coming within a predetermined margin of the supply quantity of animal medicine.

3. A method for automated animal medicine inventory control, comprising the steps of:
recording to a database of a computer the arrival of a supply quantity of an animal medicine into an animal injection environment;
simultaneously injecting, via an intelligent syringe, an animal with an injection quantity of the animal medicine and then transmitting, responsive to actuation of the intelligent syringe, a data signal containing information relating to the actuation of the intelligent syringe and the resulting injection of the animal;
receiving the data signal from the intelligent syringe by a receiver;
storing the information contained in the data signal into a computer having a database;
automatically comparing, by a comparator in the computer, the cumulated injection quantities of the animal medicine injected by the intelligent syringe to the supply quantity of the animal medicine as recorded in the database; and
transmitting an automated order for delivery of another supply quantity to the animal injection environment from an animal medicine supplier, responsive to the cumulated injection quantities coming within a predetermined margin of the supply quantity of animal medicine.
